(19) United States
(12) Patent Application Publication
(10) Pub. No.: US 2010/0169809 A1
(43) Pub. Date: Jul. 1, 2010

(54) Method And System For Managing Visually Related Multimedia Information By Means Of Dimensional Classification

(76) Inventors: Ann Lerene McCarthy, Lexington, KY (US); Mark James Owens, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/347,152

(22) Filed: Dec. 31, 2008

(51) Int. Cl. G06F 3/048

(52) U.S. Cl. 715/764

(57) ABSTRACT

Disclosed are a method and a system for managing visually related multimedia information. The visually related multimedia information comprises a plurality of information elements; each information element of the plurality of visually related multimedia information elements is associated with one or more characteristics. Each characteristic of the visually related multimedia information is associated with a dimension of an information volume. A user input is received for positioning the one or more information elements along at least one dimension of the one or more dimensions of the information volume. Each information element of the plurality of visually related multimedia information elements is positioned along the one or more dimensions of the information volume. Positioning a visually related multimedia information element classifies the information element. One or more information elements of the plurality of dimensionally positioned visually related multimedia information elements is retained as an information volume of at least one dimension. One or more information elements of the plurality of dimensionally positioned visually related multimedia information elements is displayed to the user distributed over a spatial region according to a dimensional display representation in which spatial proximity among the one or more visually related multimedia information elements along each of the at least one dimensions of the dimensional display representation represents the aspects of similarity and dissimilarity in the characteristic identified with each said dimension. A user input is received to determine the dimensional display representation from the dimensions of the information volume and to determine the orientation and viewpoint of the dimensional display representation.

### CROSS REFERENCES TO RELATED APPLICATIONS

None

### STATEMENT REGARDING FEDERALLY SPONSORED RESEARCH OR DEVELOPMENT

None

### REFERENCE TO SEQUENTIAL LISTING, ETC

None

### BACKGROUND

1. Field of the Disclosure

The present disclosure relates generally to content management mechanisms, and, more particularly, to a method and a system for managing visually related multimedia information.

2. Description of the Related Art

With rapid advances in multimedia technologies there has been an exponential increase in the volume of generated multimedia information. Multimedia information may include one of or combinations of visual content, such as images and videos, and, non-visual content, such as music and data. The multimedia information may typically be stored in data processing devices, such as personal computers, laptops, servers, and the like. A number of techniques for managing, i.e., classifying, storing and retrieving, the multimedia information, have been devised to facilitate ease of access to the multimedia content for users.

Typically, the multimedia information is classified and stored using alphanumeric keywords. For example, a visual information element, such as an image or a photograph, may be stored by a user using a unique alphanumeric keyword. The alphanumeric keyword for the visual information element may be based on some characteristic of content of the visual information element, such as presence of an identified human in the visual information element or geographic information pertaining to the content of the visual information element or chronological information pertaining to the content of the visual information element. The user may then retrieve the visual information element using the alphanumeric keyword associated with the visual information element.

Using the alphanumeric keywords for storing and retrieving the multimedia content and especially the visual information content may be cumbersome for a large visual information content set. Further, visual information elements are not inherently associated with the alphanumeric keywords, and, as such, the alphanumeric keywords must be synthetically created and associated with each visual information element of the visual information content. Since the alphanumeric keywords are synthetically created, the alphanumeric keywords describe the visual information elements associated with the alphanumeric keywords in an approximate fashion. During particular retrieval occasion, a particular alphanumeric keyword associated with a visual information element may not be well suited to the particular retrieval goal and the visual information element may be missed.

Moreover, using alphanumeric keywords can be especially burdensome for certain users, such as photographers, who deal with large visual information content sets, and, in most cases with subtle visual variations among the visual information elements of the visual information content sets. Moreover, assigning the alphanumeric keywords to the visual information elements is especially an unnatural process for visually oriented users who find translation to and from the alphanumeric keywords unintuitive for managing visual information content.

Furthermore, in typical multimedia information storage and retrieval systems, during retrieval the visual information elements are displayed in a sequential, planar manner. The sequential, planar arrangement of the visual information elements requires sequential viewing of the visual information elements, and, as such, does not provide visual cues conveying the characteristic relationships among the retrieved visual information elements.

Based on the foregoing, there is a need for improvement in managing, i.e., classifying, storing, retrieving, and displaying for user interaction, visually related multimedia content. Further, there is a need for managing the visually related multimedia content precluding discrete on/off descriptors such as alphanumeric keywords. Furthermore, there is a need for enabling users to manage large visually related multimedia content sets based on characteristics of the information elements of the visually related multimedia content in a natural and intuitive manner. Furthermore, there is a need for providing visual cues describing characteristic relationships among the information elements in the visually related multimedia content in order to facilitate managing the information elements of the visually related multimedia content.

### SUMMARY OF THE DISCLOSURE

In view of the foregoing disadvantages inherent in the prior art, the general purpose of the present disclosure is to provide a method, a system and a computer program product for managing, i.e., classifying, storing, retrieving, and displaying for user interaction, visually related multimedia information to include all the advantages of the prior art, and to overcome the drawbacks inherent therein.

Therefore, in one aspect, the present disclosure provides a system for managing visually related multimedia information. The visually related multimedia information comprises a plurality of information elements with each information element of the plurality of visually related multimedia information elements associated with one or more characteristics. The system comprises a display module, a definition module, a classification module, and storage module. The display module is capable to display one or more dimensions to a user, furthermore the display module is capable to display one or more dimensionally positioned visually related multimedia information elements to the user. The definition module is capable to associate each characteristic of the one or more characteristics of the visually related multimedia information with a dimension of an information volume, the information volume thereby having one or more continuously valued characteristic dimensions of interest. The classification module is capable to receive a user input from the user for positioning one or more information elements of the plurality of visually related multimedia information elements along at least one dimension of the one or more characteristic dimensions. Each information element of the plurality of visually related multimedia information elements is positioned along the one or more dimensions of the information volume. Positioning an information element of the plurality of visually related multimedia information elements classifies the information element, the information volume thereby comprises a plurality of dimensionally positioned, and thereby classified, visually related multimedia information. The storage module is capable to retain an information volume organized according to one or more continuously valued characteristic dimensions of interest. The display module is further capable to display one or more classified information elements of the plurality of visually related multimedia information elements for at least one dimension to the user.

Further, in another aspect, the present disclosure provides a method for managing visually related multimedia information. The visually related multimedia information comprises a plurality of information elements, each information element of the plurality of visually related multimedia information elements associated with one or more characteristics. One or more characteristics pertaining to visually related multimedia information are identified and each characteristic is managed as a continuously valued dimension of interest in the storage and display of visually related multimedia information. A user input is received from the user for positioning one or more information elements of the plurality of visually related multimedia information elements along at least one dimension of the one or more dimensions. Each information element of the plurality of visually related multimedia information elements is positioned along the one or more characteristic dimensions. Positioning an information element of the plurality of visually related multimedia information elements classifies the information element. One or more characteristic dimensions are displayed to the user. One or more information elements of the plurality of visually related multimedia information elements are classified along based on the one or more classified information elements displayed for the at least one dimension. The plurality of dimensionally positioned, and thereby classified, visually related multimedia information elements is retained as an information volume organized according to the one or more continuously valued characteristic dimensions of interest. One or more classified information elements of the plurality of visually related multimedia information elements for the at least one dimension of the information volume are displayed to the user. One or more dimensions are displayed to a user such that one or more information elements of the plurality of dimensionally positioned visually related multimedia information elements are distributed over a spatial region according to a dimensional display representation in which spatial proximity among the one or more visually related multimedia information elements along each of the at least one dimensions represents the aspects of similarity and dissimilarity in the characteristic identified with the said dimension. Furthermore, the dimensional display representation of the information volume, comprising one or more continuously valued characteristic dimensions, and the associated displayed information volume, comprising a plurality of dimensionally positioned visually related multimedia information elements, is adjusted based on one or more received user dimensional orientation and viewpoint requests.

The user can classify an information element based on a visual comparison with previously classified visually related multimedia information elements, and accordingly position the information element along the at least one dimension of an associated information volume having dimensions corresponding to visually related multimedia information characteristics of interest. The user can then selectively retrieve at least one information element of the retained classified visually related multimedia information elements along a chosen visually portrayed dimension. Such mechanisms enable the user to classify, store, retrieve, and interact with, i.e., manage, visually related multimedia information in an effective manner. Further, classifying, storing, retrieving and interacting with visually related multimedia information using such mechanisms precludes the need for on/off descriptors, such as alphanumeric keywords. Furthermore, the user can now classify, store, retrieve, and interact with large visually related multimedia information sets based on characteristics of information elements in each visually related multimedia information set in a natural and intuitive manner. Furthermore, displaying the classified visually related multimedia information elements along the each dimension, such that spatial proximity provides visual cues describing characteristic relationships among the information elements to the user, facilitates selectively storing, retrieving, and interacting with visually related multimedia information in a satisfactory and less burdensome manner.

### BRIEF DESCRIPTION OF THE DRAWINGS

The above-mentioned and other features and advantages of the present disclosure, and the manner of attaining them, will become more apparent and the present disclosure will be better understood by reference to the following description of embodiments of the present disclosure taken in conjunction with the accompanying drawings, wherein:

FIG. 1 is a block diagram of a system for managing visually related multimedia information in a data processing device, in accordance with an embodiment of the present disclosure;

FIG. 2 is a flow diagram depicting a method for classifying and storing the visually related multimedia information, in accordance with an embodiment of the present disclosure;

FIG. 3 is a flow diagram depicting a method for retrieving and displaying the classified visually related multimedia information, in accordance with an embodiment of the present disclosure;

FIGS. 4A and 4B depict screenshots of an exemplary human-non human dimension of the one or more dimensions displayed to a user for positioning of one or more information elements of the visually related multimedia information along the human-nonhuman dimension, in accordance with an embodiment of the present disclosure; and

FIGS. 5A and 5B depict screenshots of exemplary distributions of the information volume of the classified visually related multimedia information (of FIGS. 4A and 4B) over a spatial region displayed to the user during retrieval of one or more classified information elements, in accordance with an embodiment of the present disclosure.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein, is meant to encompass the items listed thereafter and equivalents thereof, as well as, additional items.

In addition, it should be understood that embodiments of the present disclosure include both hardware and electronic components or modules that, for purposes of discussion, can be illustrated and described as if the majority of the components were implemented solely in hardware. However, one of ordinary skill in the art, and based on a reading of this detailed description, would recognize that, in at least one embodiment, the electronic based aspects of the present disclosure can be implemented in software. As such, it should be noted that a plurality of hardware and software-based devices, as well as a plurality of different structural components can be utilized to implement the present disclosure.

The present disclosure provides a method and a system for managing visually related multimedia information. The visually related multimedia information comprises a plurality of information elements with each information element of the plurality of visually related multimedia information elements having one or more characteristics of interest. One or more characteristics of the visually related multimedia information are determined. Each said identified characteristic is managed as, and associated with, a continuously valued dimension of interest determining an information volume used in the classification, storage, and display of said visually related multimedia information. One or more said dimensions of interest are selectively displayed to a user, as representing the information volume organized according to the one or more continuously valued characteristic dimensions of interest. Each information element of the plurality of visually related multimedia information elements is positioned along the one or more dimensions. A user input can be received from the user for positioning an information element of the plurality of visually related multimedia information elements along at least one dimension of the one or more dimensions. Positioning an information element of the plurality of visually related multimedia information elements along the one or more said continuously valued dimensions classifies the information element according to the characteristic identified with the said dimension. The one or more classified information elements of the plurality of visually related information elements are retained as an information volume organized according to one or more continuously valued characteristic dimensions of interest. The said information volume comprises a plurality of dimensionally positioned, and thereby classified, visually related multimedia information elements. The one or more classified information elements of the plurality of visually related multimedia information elements are displayed to the user according to a dimensional display representation in which spatial proximity among the one or more visually related multimedia information elements along each of the at least one dimensions represents the aspects of similarity and dissimilarity in the characteristic identified with the said dimension.

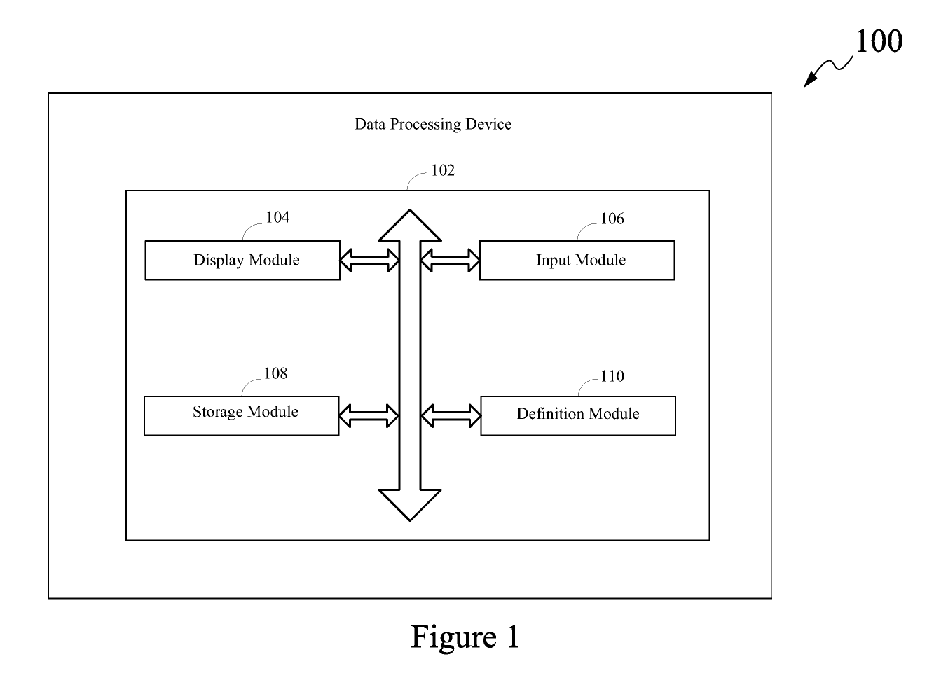

Referring now to the drawings and particularly to FIG. 1, there is shown a block diagram of a data processing device 100 including a system 102 for managing visually related multimedia information (not shown) in data processing device 100. Further, description of FIG. 1, also describes a method for managing the visually related multimedia information in data processing devices, such as data processing device 100. Examples of data processing device 100 include a personal computer, a laptop, a Personal Digital Assistant (PDA), a computer network server, and the like. The visually related multimedia information includes a plurality of information elements. Examples of visually related multimedia information elements include, but are not limited to, images, video files, animation clips, and the like. Each information element of the plurality of visually related multimedia information elements is associated with one or more characteristics. For the purpose of this description, a characteristic of the one or more characteristics is an attribute exhibited by an information element. For example, an information element, such as an image of a human being standing in a garden includes the one or more characteristics such as, a human characteristic and a nature characteristic.

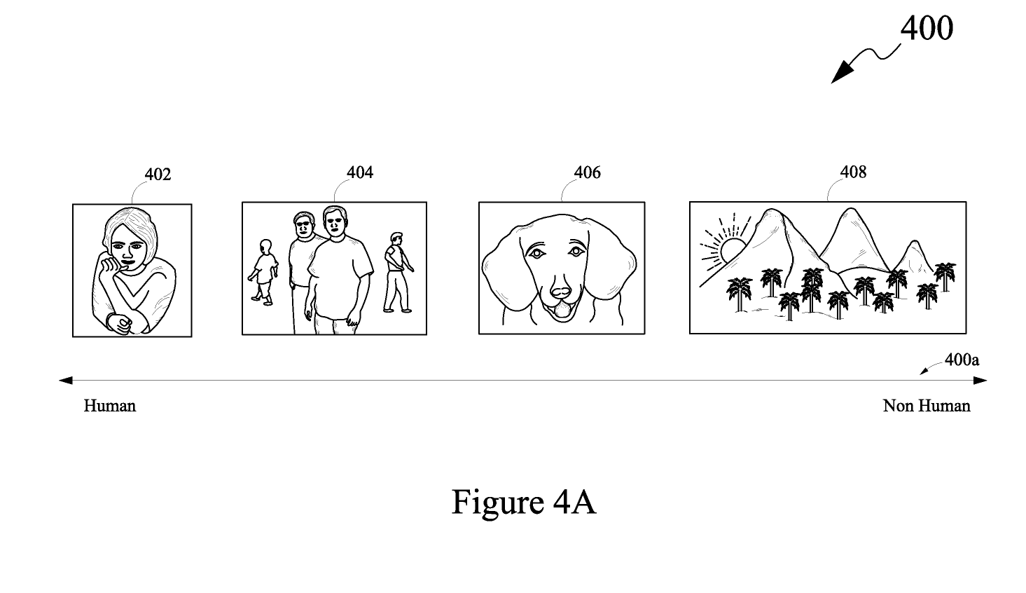

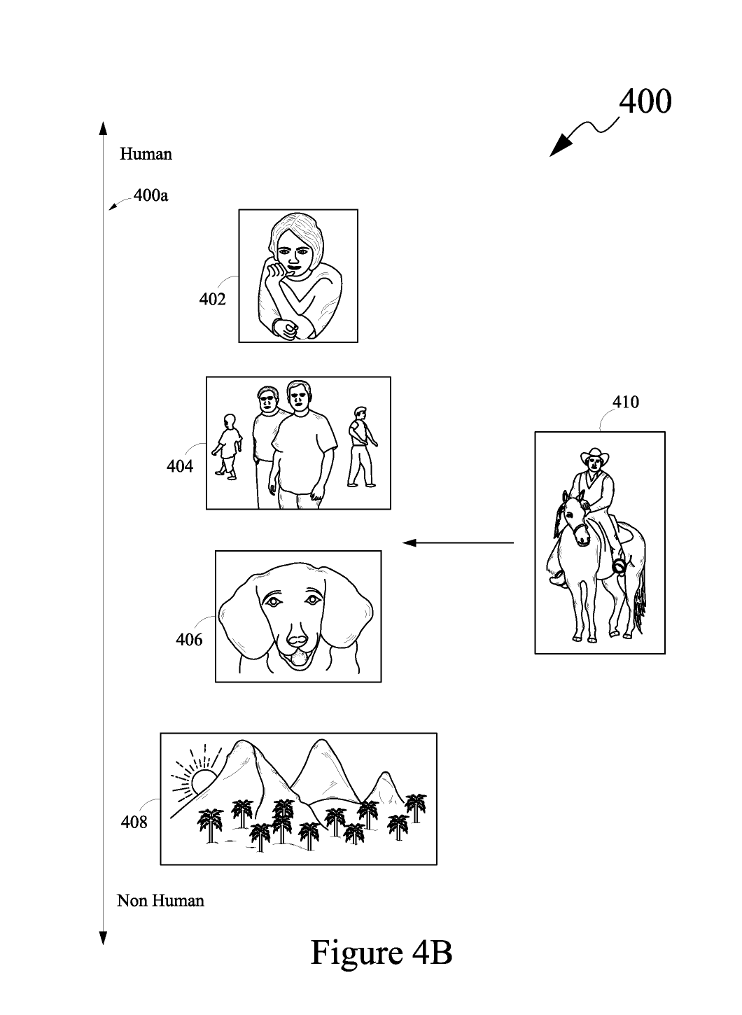

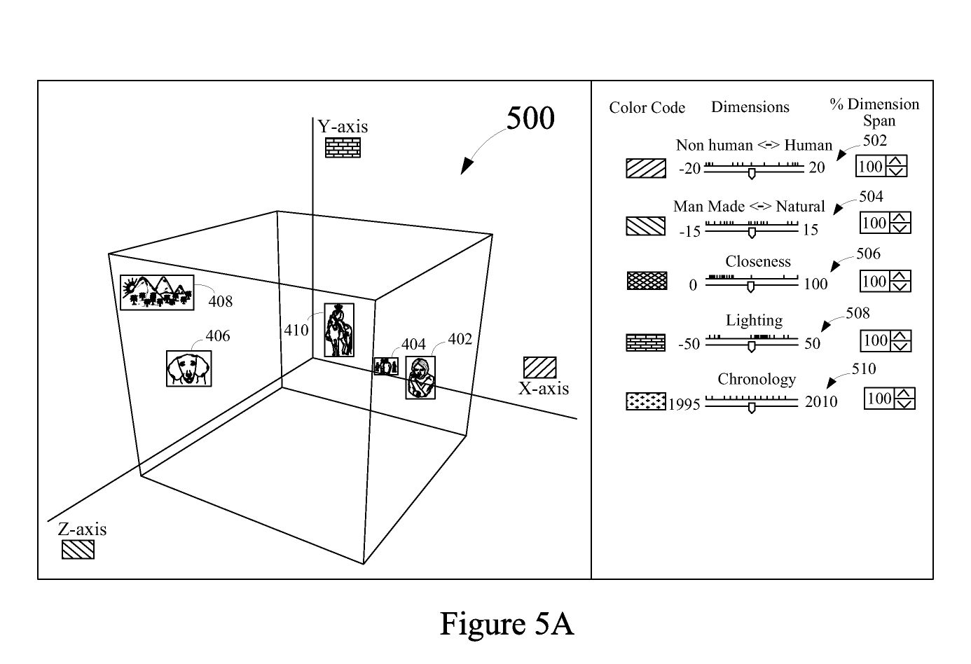

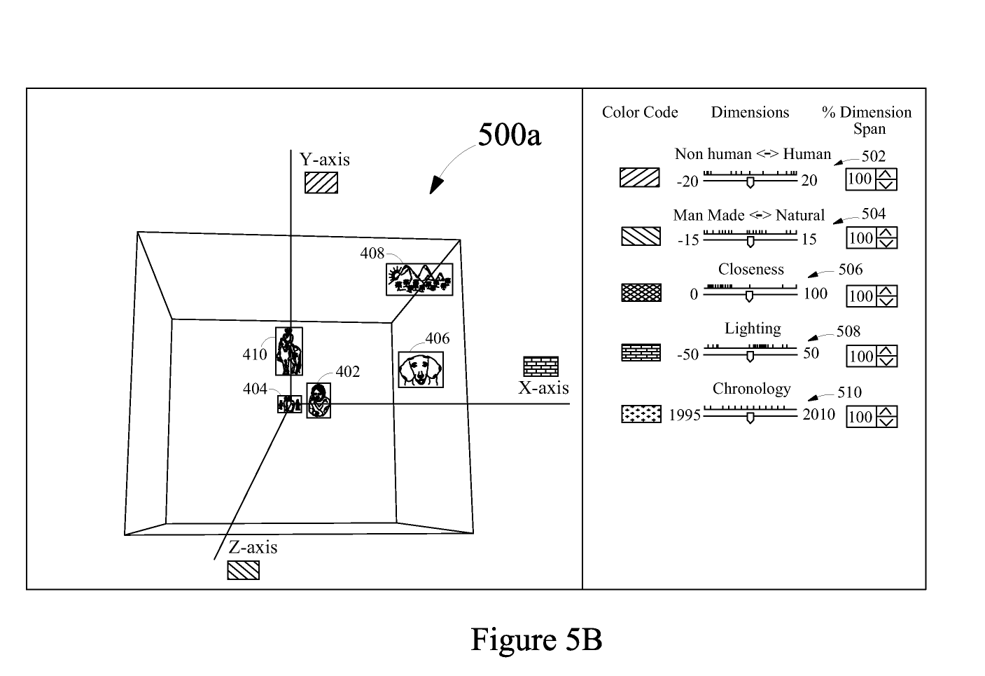

As depicted in FIG. 1, system 102 includes a display module 104, an input classification module 106, a storage module 108 and a definition module 110. Display module 104 is capable of displaying one or more dimensions to a user. Each dimension of the one or more dimensions is associated with a characteristic of the one or more characteristics. For example, display module 104 can display the one or more dimensions, such as, a ‘human-non human’ (i.e., presence of human or non human characteristics) dimension, a ‘manmade-natural’ dimension and a ‘degree of proximity’ dimension, to the user. Further, the each dimension can be displayed by display module 104 as a continuously valued dimension. Examples of display module 104 include physical display devices such as a Cathode Ray Tube (CRT) monitor, a Liquid Crystal Display (LCD) screen, a touch screen monitor, and the like, and the associated information display function as described herein, implemented in computer software or hardware. Further, display module 104 is capable to receive user input from a user to change the dimensional orientation of the dimensional display representation, comprising the one or more continuously valued characteristic dimensions, and the associated displayed information volume, comprising a plurality of dimensionally positioned visually related multimedia information elements. For example, FIG. 4A depicts a human-non-human dimension along an X-axis, and FIG. 4B depicts a human-non-human dimension along a Y-axis. For example, FIGS. 5A and 5B show two different orientations of a dimensional information volume that display module 104 is capable to provide.

Input classification module 106 is capable of receiving a user input from the user for positioning one or more information elements of the plurality of visually related multimedia information elements along at least one dimension of the one or more dimensions. It will be obvious to a person skilled in the art that the user input will be received for each information element of the plurality of visually related multimedia information elements, such that, each information element of the plurality of visually related multimedia information elements is positioned spatially along the at least one dimension. Positioning the information element along the at least one dimension of the one or more dimensions classifies the information element. More specifically, positioning the information element along each dimension of the at least one dimension classifies the information element according to the characteristic identified with the each dimension. Examples of input classification module 106 include physical input devices such as a keyboard, a mouse, a joystick, a touch screen, and the like, and the associated classification function as described herein, implemented in computer software or hardware.

In the function of input classification module 106 and display module 104, each information element of the plurality of visually related multimedia information elements is classified as positioned along the at least one dimension of the one or more dimensions for facilitating storage and retrieval of the each information element. For example, for positioning and thus classifying an information element, such as an image of a group of school boys, the human-non human dimension can be displayed to the user by display module 104. The human-non human dimension can be displayed to the user in form of an axial line, such as an X axis, with one end corresponding to a maximum possible human characteristic and an opposite end corresponding to a maximum possible non human characteristic. The image of the group of school boys can then be positioned relative to the end corresponding to the maximum possible human characteristic, thereby classifying the image of the group of school boys as primarily human, according to the visual judgment of the user. In an embodiment of the present disclosure, the information element can be classified by an algorithmic analysis of the information element included in the function of input classification module 106.

Display module 104 is further capable of displaying to the user one or more classified information elements of the plurality of visually related multimedia information elements distributed over a spatial region according to a dimensional display representation of the one or more dimensions. Further, according to the function of input classification module 106, one or more information elements of the plurality of visually related multimedia information elements can be classified along the at least one displayed dimension by visual comparison to the one or more previously classified information elements displayed for the at least one dimension.

For example, for classifying an information element, such as an image of a child, the human-non human dimension can be displayed to the user along with the classified image (of the group of school boys) placed near the end corresponding to the maximum possible human characteristic. The image of the child can then be visually compared with the image of the group of school boys and can accordingly be positioned to a right side or a left side of the image of the group of school boys on the axial line, i.e., on the human-non human dimension, for classifying the image of the child according to the visual judgment of the user. Thus, for classifying the one or more information elements of the plurality of visually related multimedia information elements, at least one dimension of the one or more dimensions, such as the human-non human dimension, is displayed to the user in addition to the previously classified information elements for the at least one dimension. For a displayed dimension, the user can visually compare an information element to be classified with the previously classified information elements that are displayed, and accordingly position the information element on the displayed dimension, thus classifying the information element. The spatial proximity among the classified information elements along the at least one dimensions represents the aspects of similarity and dissimilarity among the classified information elements, in the characteristic associated with the dimension. Display module 104 can be configured to display a subset range of a displayed dimension by selecting exemplar dimensionally positioned information elements, i.e., information elements classified according to the dimension, or by selecting a subset of a numeric scale associated with the continuously valued dimension.

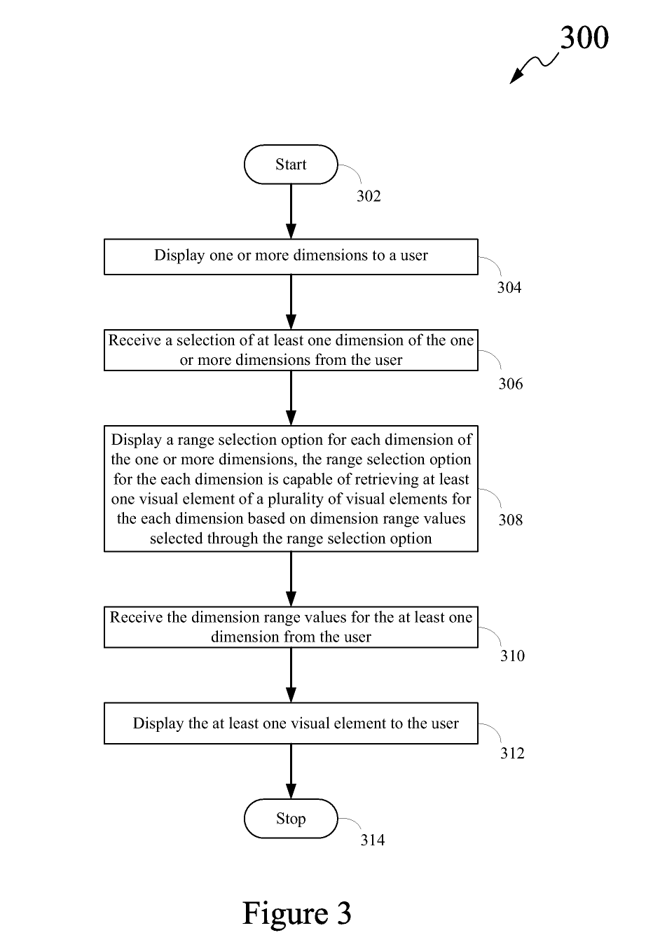

The classified information elements of the plurality of visually related multimedia information elements are stored in storage module 108. Examples of storage module 108 include physical devices such as a Random Access Memory (RAM), a Read Only Memory (ROM), or any such other storage device, and the associated information storage function as described herein, implemented in computer software or hardware. Storage module 108 is configured to retain classified information elements organized according to one or more continuously valued characteristic dimensions of interest, according to the dimensional positioning and hence classification of each information element. The classification values associated with each information element are utilized for arranging the classified information elements in an information volume, having dimensions corresponding to the characteristic dimensions of interest. In an embodiment of the present disclosure, storage module 108 can be configured to retain the discrete classification values associated with the classified information elements, used for organizing the classified information elements in the dimensional information volume. For retrieving the at least one information element of the classified information elements, at least one dimension of the one or more dimensions can be selected by the user, based on characteristics of the at least one information element to be retrieved. Further, the user can select a region of the at least one dimension corresponding to the classified information element to be retrieved. The retrieval of the at least one information element will be explained in conjunction with FIGS. 3, 5A and 5B.

Definition module 110 is capable of defining the one or more dimensions, such as the human-non human dimension, prior to displaying the one or more dimensions to the user. In an embodiment of the present disclosure, a dimension of the one or more dimensions is defined by definition module 110 based on a user input, whereby the user identifies a characteristic pertaining to visually related multimedia information, each such identified characteristic to be managed as a continuously valued dimension of interest in the classification, storage and display of visually related multimedia information. The user can provide the user definition of a dimension in accordance with the characteristics of interest of one or more sets of visually related multimedia information. For example, for classifying and storing the one or more information elements, such as images of a wedding ceremony, a user may define a ‘bride-groom’ dimension, i.e., an axis with one end corresponding to images of a bride and an opposite end corresponding to images of a groom. It will be evident to those skilled in the art that images corresponding more or less to both the bride and the groom can be positioned in-between the one end and the opposite end of the bride-groom dimension, such that the ‘bride-groom’ dimension can be managed as a continuously valued dimension. Accordingly, the at least one dimension corresponding to the at least one characteristic identified, can be displayed to the user in coordination with the function of display module 104.

In another embodiment of the present disclosure, definition module 110 can be capable of providing a user interface to the user through display module 104 for enabling the user to define a dimension of the one or more dimensions. The user interface for enabling the user to define the dimension can include text boxes, drop-down boxes, and the like, for receiving information of the dimension to be defined, such as a name of the dimension.

In an embodiment of the present disclosure, display module 104 is capable of displaying a range selection option for each dimension of the one or more dimensions of interest of an information volume. The range selection option for the each dimension is capable of retrieving the at least one information element of the plurality of visually related multimedia information elements based on dimension range values selected through the range selection option for the each dimension. For example, for a dimension ‘degree of proximity’ (hereinafter referred to as ‘proximity dimension’) of the one or more dimensions, a dimension range value can extend from a value−100 at one end of the axis to a value+100 at an opposite end of the axis. Similarly, for a chronology dimension of the one or more dimensions, one end of an axis representing the chronology dimension can correspond to year 1990 and an opposite end of the axis can correspond to year 2010 with each information element positioned along the chronology dimension and assigned a value corresponding to a year in which the each information element was recorded. The user may provide a dimension range value of 2005 to 2008 for the chronology dimension, and a dimension range value of −50 to 100 for the proximity dimension for retrieving information elements recorded between years 2005 and 2008 with a degree of proximity corresponding to the dimension range value of −50 to 100. It will be apparent to a person skilled in the art that each dimension of the one or more dimensions can have an adaptive extent that can adjust based on the one or more information elements that are classified. An information element that is classified at an extremity of a particular dimension can extend the range of that dimension.

Input module 106 can be configured to receive the dimension values for the at least one dimension of the one or more dimensions of interest in classifying an information element. It will be obvious to a person skilled in the art that input module 106 can be configured to receive integer values, decimal values, fraction values, or similar dimension values. In an embodiment of the present disclosure in the function of the input classification module 106, positioning the information element along the each dimension of the at least one dimension can associate a classification value with the information element for the each dimension based on the position. Storage module 108 can be configured to store the classified information elements along with classification values of the classified information elements for the at least one dimension. The classification values can be received from the user as the user input. For example, a classified information element, such as a close-up image of a baby recorded in 2005, can be stored by storage module 108 along with the classification values of the classified information element for each dimension of the at least one dimension namely, the human-non human dimension, the proximity dimension and the chronology dimension, as 10, 20 and 2005, respectively classifying the image as primarily human, with a proximity of 20 inches, recorded in 2005. In another embodiment of the present disclosure, storage module 108 can further be configured to store the definitions of the one or more dimensions.

In an embodiment of the present disclosure, display module 104 is further capable of displaying retrieved classified information elements as a distribution over a spatial region to the user. The distribution can be displayed as a two-dimensional distribution, a three-dimensional distribution or an n-dimensional distribution. Further, a numeric scale can be aligned along each dimension in the two-dimensional, three-dimensional or n-dimensional distributions. For example, a two dimensional distribution of the at least one information element retrieved, can include a display of axial lines, such as an X-axis and a Y-axis, with the at least one information element positioned along each of the axial lines. A three-dimensional distribution of the at least one information element over the spatial region can be depicted as a cuboid with three dimensions displayed along three axes of the cuboid. For example, the at least one information element retrieved for each of the three dimensions, such as the human-non human dimension, the proximity dimension, and the chronology dimension, can be displayed in the spatial volume of the cuboid with a spatial position for each characteristic of the at least one information element in the information volume. The spatial position for the each classified information element corresponds to co-ordinates in the information volume based on values assigned to the each classified information element by positioning the information element along the three dimensions. Further, the information volume of the cuboid corresponds to the dimension range values provided by the user for the three dimensions. It will be apparent to a person skilled in the art that display module 104 can display the two-dimensional distribution, the three-dimensional distribution or the n-dimensional distribution based on the physical dimensional capabilities of display module 104.

In an embodiment of the present disclosure, the user can zoom into a spatial region of the displayed spatial distribution of the information volume by providing the dimension range values through the range selection option. The user can derive visual cues describing characteristic relationships among the classified information elements by zooming into the spatial region. In an embodiment of the present disclosure, the user can be enabled to adjust a displayed size of the classified information elements in the spatial region.

In an embodiment of the present disclosure, display module 104 is configured to receive an orientation input from the user. The orientation input is capable of determining orientation of the at least one dimension. In another embodiment of the present disclosure, display module 104 is capable of displaying the at least one dimension to the user based on the orientation input. The orientation input can include information of axis assignment of each dimension of the at least one dimension. For example, the axis assignment of the at least one dimension, namely, the human-non human dimension, the manmade-natural dimension and the proximity dimension can be, the human-non human dimension on an X axis, the manmade-natural dimension on a Y axis and the proximity dimension on a Z axis. In yet another embodiment of the present disclosure, the orientation input can include information of an axis about which the at least one dimension can be rotated. Further, a degree of rotation can also be specified by the user in the orientation input. In still another embodiment of the present disclosure, the orientation input can also include information of location of a viewpoint of the user for viewing the at least one dimension from the viewpoint.

It will be apparent to a person skilled in the art that each component of system 102, such as display module 104, input classification module 106, storage module 108 and definition module 110 can be implemented as a hardware module, a software module, a firmware module, or any combination thereof. Further, it will be obvious to those skilled in the art that system 102 can include requisite electrical connections or other connections for communicably coupling the various components of system 102. Furthermore, it will be evident to those skilled in the art that data processing device 100 can include typical components (not shown), such as a battery unit and a microprocessor for performing typical functions of data processing device 100.

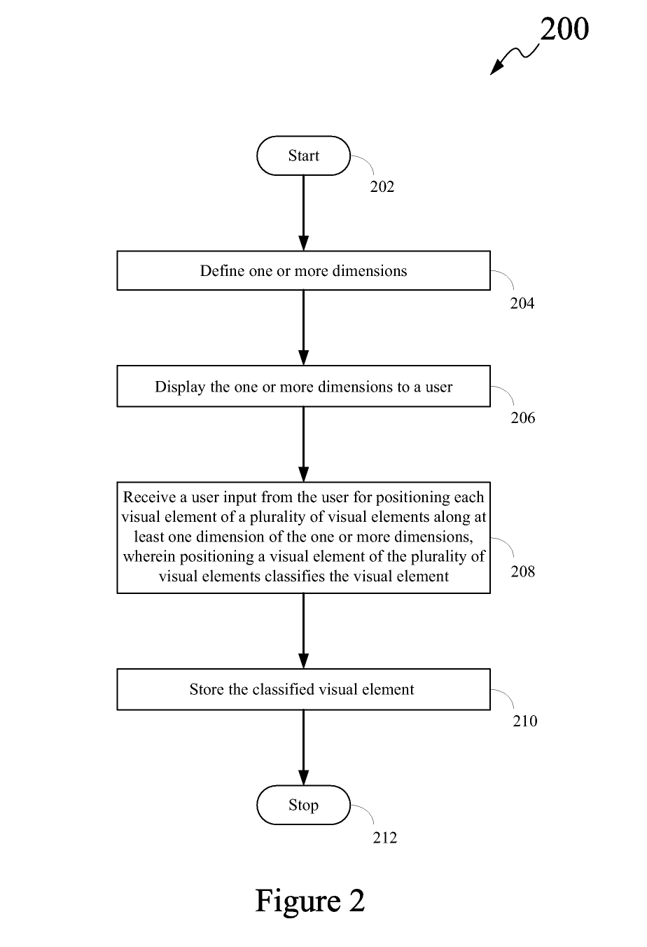

The managing of visually related multimedia information, for example in a data processing device such as data processing device 100, can also be explained by the following method. Each information element of a plurality of visually related multimedia information elements is associated with one or more characteristics. A user with interest in managing the visually related multimedia information according to those characteristics identifies one or more characteristics pertaining to the visually related multimedia information, with the intent that each such identified characteristic is to be managed as a continuously valued dimension of interest in the storage and display of the visually related multimedia information. The identified one or more dimensions are displayed to the user. Each dimension of the one or more dimensions pertains to a characteristic of the one or more characteristics. A user input is received from the user for positioning one or more information elements of the plurality of visually related multimedia information elements along at least one dimension of the one or more dimensions. Each information element of the plurality of visually related multimedia information elements is positioned along the one or more dimensions. Positioning an information element of the plurality of visually related multimedia information elements classifies the information element according to the characteristic identified with the dimension. The one or more classified information elements of the plurality of visually related multimedia information elements for the at least one dimension are displayed to the user. The one or more information elements of the plurality of visually related multimedia information elements are classified along the at least one dimension relative to the other one or more classified information elements displayed for the at least one dimension, and relative to the scale of the continuously valued dimension. Positioning the one or more information elements of the plurality of visually related multimedia information elements along the at least one dimension facilitates ease in storage and retrieval of the one or more information elements, thereby enabling the user to manage the visually related multimedia information. The classification, storage and the retrieval of the visually related multimedia information are explained in conjunction with FIGS. 2 and 3.

FIG. 2 is a flow diagram depicting a method 200 for classifying and storing the visually related multimedia information, for example in a data processing device such as data processing device 100, in accordance with an embodiment of the present disclosure. The visually related multimedia information includes a plurality of visually related multimedia information elements with each information element of the plurality of visually related multimedia information elements associated with one or more characteristics. Method 200 starts at 202. At 204, one or more dimensions, such as the one or more dimensions explained in conjunction with FIG. 1, can be defined. The one or more dimensions can be pre-defined in the data processing device by a definition module, such as definition module 110. For example, the one or more dimensions can be pre-defined as a human-non human dimension, a manmade-natural dimension and a proximity dimension. In an embodiment of the present disclosure, a dimension of the one or more dimensions is defined based on a user definition received by the data processing device using a definition module, such as definition module 110. The user definition includes a definition of a dimension configured by the user to suit the characteristics of a particular visually related multimedia information set and can be intended to satisfy a particular storage and/or retrieval goal. For example, for storing visually related multimedia information, such as images of a wedding ceremony, the user may define a bride-groom dimension. In an alternative embodiment of the present disclosure, the one or more dimensions can be defined, such as by the definition module 110, according to algorithmic analysis of the visually related multimedia information set. For example, it is known to those skilled in the art that exposure level of images can be determined by means of algorithmic analysis and thus an exposure level characteristic for image information elements can be defined and managed by means of algorithmic analysis. Each defined dimension is managed as a continuously valued dimension of interest in the classification, storage and display of visually related multimedia information. Each defined dimension portrays the range of a characteristic of interest in the visually related multimedia information. The range of the characteristic, and hence the range of values of the corresponding dimension, can be defined according to a received user input, for example according to a numeric scale or by reference to exemplar information elements of the extremes of the characteristic. Alternatively, in another embodiment of the present disclosure, the one or more dimensions can be defined, such as by the definition module 110, each having an adaptive extent according to the characteristics of the information elements of the plurality of visually related multimedia information elements encountered during classification of the information elements. Alternatively, in another embodiment of the present disclosure, a dimension can be defined, such as by the definition module 110, pertaining to a characteristic to be managed as an ordered sequence of discrete characteristic values aligned along the continuously valued dimension. The values of the characteristic having a sequence of discrete values can be defined according to received user input or can be defined adaptively by function of the definition module according to the characteristic values encountered in a visually related multimedia information set. For example, as depicted in FIG. 5A, the chronology dimension portrays the sequence of discrete characteristic year values from 1995 to 2010. Further in this example according to the present disclosure, a definition module, such as definition module 110, can adaptively extend the value range of the chronology dimension as information elements having characteristic year values outside of this range are encountered during classification. Alternatively, in another embodiment of the present disclosure, a dimension can be defined, such as by the definition module 110, pertaining to a characteristic to be managed according to a numeric scale aligned along the continuously valued dimension. The range of the numeric scale values of the characteristic can be defined according to received user input or can be defined adaptively by function of the definition module according to the characteristic values encountered in a visually related multimedia information set. For example, as depicted in FIG. 5A, the closeness dimension portrays the closeness characteristic as a numeric scale having values from 0 to 100.

At 206, the one or more dimensions can be displayed to the user by the data processing device using a display module, such as display module 104. The one or more dimensions are continuously valued dimensions. The user can identify at least one characteristic related to an information element that needs to be classified. At 208, a user input can be received from the user for positioning the information element of one or more information elements along at least one dimension of the one or more dimensions. The user input can include information of a position on a dimension of the at least one dimension for placing the information element. Alternatively, the user can position the information element along each of the one or more dimensions displayed to the user. For example, the user can position an information element, such as an image of a hunter in a forest, along each of the human-nonhuman dimension, the manmade-natural dimension and the proximity dimension, displayed to the user. The user input can include spatial positioning information aligning the information element according to the displayed spatial region of a displayed dimension. The user can position the information element along each of the one or more dimensions displayed to the user by providing values of the positions on each of the one or more dimensions, mouse clicks on the positions, and the like. The user input can be received through key strokes on a keyboard, dragging and placing the information element at a position on each dimension of the at least one dimension, movement of a joystick on the each dimension, and the like.

Positioning the information element classifies the information element. More specifically, positioning the information element along each dimension of the at least one dimension classifies the information element according to the characteristic identified with the each dimension. In an embodiment of the present disclosure, one or more information elements can be classified by an algorithmic analysis of the information element. In another embodiment of the present disclosure, a user can classify one or more information elements according to the characteristic identified with a dimension by comparison to exemplar previously classified information elements. For example, as depicted in FIG. 4B, given exemplars of previously classified information elements 402 and 408 portraying distinctly different aspects of the human-non-human dimension characteristic, information element 404 can be classified as more similar to information element 402 and less similar to information element 408. Further in this example, the information element 404 can be classified in the human-non-human dimension characteristic according to a user input providing spatial positioning of information element 404 relative to displayed exemplars 402 and 408. Spatial proximity of the information element 404 in relation to the exemplars, information elements 402 and 408, portrays aspects of similarity and dissimilarity among the classified information elements, in the characteristic associated with the displayed dimension.

At 210, the each classified of the one or more information elements is stored as an information element of an information volume, such as by a data processing device, using a storage module, such as storage module 108. The stored information volume of the plurality visually related multimedia information elements is organized according to the one or more continuously valued characteristic dimensions. The information volume comprises a plurality of dimensionally positioned, and thereby classified, visually related multimedia information elements. The classification values, corresponding to dimensional spatial positioning values, for the classified information element are also stored. The spatial positioning values can be utilized for arranging the classified information elements in the spatial organized information volume. It will be apparent to a person skilled in the art that the dimensionality of the stored information volume corresponds to the number of the characteristics of interest in the plurality visually related multimedia information elements and is not limited to the dimensionality of a physical display.

In an embodiment of the present disclosure, the at least one dimension for classifying the information element is displayed to the user along with classified information elements stored in the storage module. The classified information elements are retrieved from the storage module and arranged along a dimension of the at least one dimension based on classification values associated with the classified information elements for the dimension. The user can classify the information elements along the dimension based on a visual comparison of the information element with the arranged classified information elements. The visual comparison will be explained in detail in FIGS. 4A and 4B.

At 212, method 200 ends. It will be apparent to a person skilled in the art that the user input can be received for each information element of the classified information elements. Further, the classified information elements of the plurality of visually related multimedia information elements can be retrieved by the user. A method for retrieving the visually related multimedia information from the data processing device is explained in detail in FIG. 3.

FIG. 3 is a flow diagram depicting a method 300 for retrieving the visually related multimedia information, in accordance with an embodiment of the present disclosure, for example from a data processing device. Method 300 starts at 302. At 302, a user of the stored information volume organized according to one or more continuously valued characteristic dimensions may need to retrieve at least one classified information element of the plurality of dimensionally positioned, and thereby classified, visually related multimedia information elements of the information volume using, for example a data processing device such as data processing device 100. A dimensional display representation of one or more dimensions of the one or more dimensions of the information volume is determined according to the one or more continuously valued characteristics of interest in the plurality of classified visually related multimedia information elements of the information volume. At 304, the one or more continuously valued characteristic dimensions of the information volume can be displayed to the user. At 306, a selection of at least one dimension of the one or more dimensions of the information volume can be received from the user. For example, a selection of the human-non human dimension may be received from the user to retrieve the at least one information element of the classified information elements associated with a human characteristic. In an embodiment of the present disclosure, each dimension of the one or more dimensions can be selected by default, such that the dimensions of the dimensional display representation utilize the available dimensions of a display module such as display module 104 of system 102, when no selection of the at least one dimension is received from the user. Alternatively, the user can manually select and can manually deselect the each dimension of the one or more dimensions of the information volume. In each embodiment, the one or more dimensions of the dimensional display representation can be selected such that the dimensions of the dimensional display representation are appropriate to the dimensional capabilities of a display device of a display module, such as display module 104 of system 102.

At 308, a range selection option is displayed to the user for each dimension of the at least one dimension of the information volume. The range selection option for the each dimension of the information volume is capable of identifying a selected subset of the classified information elements for the each dimension based on dimension range values, i.e., classification values, selected through the range selection option. In an embodiment of the present disclosure, the range selection option can be displayed for each dimension of the at least one dimension of the information volume. For example, the user can select the classification range values of the one or more dimensions, such as the human-non human dimension and the proximity dimension, as suitable for retrieving the at least one information element relating to close-up images of humans. The range selection option can be displayed to the user for the human-non human dimension and the proximity dimension.

At 310, the dimension range values for the at least one dimension can be received from the user for identifying the dimension range values of the dimensional display representation of the information volume. The dimension range values can be received for each dimension of the at least one dimension of the information volume, thereby identifying a selected subset in each dimension of the one or more dimensions of the information volume. At 312, the at least one information element of the information volume comprising a plurality of dimensionally positioned, and thereby classified, visually related multimedia information elements is displayed to the user. Each information element of the at least one information element can be retrieved from a storage module, such as storage module 108 of system 102. Further, classification values assigned to an information element while classifying the information element can also be retrieved from the storage module during retrieving the at least one information element. Each information element of the at least one information element can be arranged along the at least one dimension based on the classification values assigned to the each information element.

More specifically, each dimension of the at least one dimension of the dimensional display representation of the information volume can be displayed on a display module, such as display module 104. Further, each information element of the selected subset of the information volume in the dimensional display representation of the information volume can be arranged along each dimension of the at least one dimension of the dimensional display representation of the information volume based on the classification value assigned to the each information element for the each dimension. For example, an information element of the at least one information element in the dimensional display representation subset of the information volume, such as an image of a child, may have associated classification values along the human-nonhuman dimension, the proximity dimension, and the manmade-natural dimension as 50, 20 and −20, respectively. Accordingly, the image of the child can be arranged on the human-nonhuman dimension, the proximity dimension and the manmade-natural dimension based on the values 50, 20 and −20, respectively. Similarly, each information element of the at least one information element retrieved can be arranged along the each dimension of the dimensional display representation of the information volume based on the classification values associated with the each information element. Spatial proximity among the one or more classified information elements of the plurality of dimensionally positioned visually related multimedia information elements distributed over a spatial region according to the dimensional display representation portrays aspects of similarity and dissimilarity among the classified information elements, in the each characteristic associated with the each displayed dimension.

In an embodiment of the present disclosure, a distribution of the classified information elements over a spatial region can be displayed to the user. The spatial region can be one dimensional, two dimensional, three dimensional, or n-dimensional, based on the number of dimensions selected by the user as the at least one dimension, such that the dimensions of the dimensional display representation are appropriate to the dimensional capabilities of a display device, such as the display device of display module 104 of system 102. Accordingly, the distribution of the classified information elements can be displayed to the user as a two dimensional distribution, a three dimensional distribution or an n-dimensional distribution. Further, a numeric scale of classifications values, according to the classification values identified with the each dimension of the information volume, can be displayed with the each dimension of the dimensional display representation. For example, to retrieve visually related multimedia information related to nature, two dimensions, namely, a manmade-natural dimension and a lighting dimension can be received from the user. The each information element of the at least one information element retrieved can be displayed as a two dimensional distribution over a two dimensional spatial region to the user. It will be apparent to a person skilled in the art that a two-dimensional distribution, a three-dimensional distribution or an n-dimensional distribution can be displayed based on dimensional capabilities of a display module, such as display module 104 of system 102. The construction of the dimensional display representation and the display subset of the plurality of classified visually related multimedia information elements of the information volume is further explained in conjunction with FIGS. 5A and 5B below.

In an embodiment of the present disclosure, a zoomed section of the spatial region of the dimensional display representation can be displayed to the user based on dimension range values received from the user. For example, for two dimensions, namely, the manmade-natural dimension and the proximity dimension, the classified information elements can have values from −100 to 100 and from −200 to 100, respectively. Further, the distribution of the at least one information element for the two dimensions of the dimensional display representation may cover an XY plane. The user can zoom in to a specific section of the spatial region of the distribution based on specific dimension range values, i.e., −50 to 50 and 0 to 50, received from the user for zooming into the manmade-natural dimension and the proximity dimension, respectively. Further, the user may derive visual cues that describe characteristic relationships among information elements of the at least one information element by zooming into the spatial region. In an embodiment of the present disclosure, the user can be enabled to adjust a displayed size of the classified information elements in the spatial region of the dimensional display representation. It will be apparent to a person skilled in the art that each dimension of the one or more dimensions of the dimensional display representation can have an adaptive extent that can vary based on the one or more information elements that are classified. An information element that is classified at an extremity of a particular dimension extends the range of that dimension of the information volume and thus can extend the range of that dimension of the dimensional display representation if so selected.

In still another embodiment of the present disclosure, the at least one dimension of the dimensional display representation can be displayed to the user based on the orientation input received from the user. The orientation input includes the information of axis assignment of each dimension of the at least one dimension. For example, based on the orientation input received from the user, each dimension of the at least one dimension, namely, the lighting dimension and the proximity dimension, can be arranged along any one of the X axis, the Y axis and the Z axis, with each dimension displayed on a single axis. In another embodiment of the present disclosure, the orientation input can include information of an axis about which the at least one dimension is to be rotated. Further, a degree of rotation can also be specified by the user in the orientation input. In yet another embodiment of the present disclosure, the orientation input can also include information of location of a viewpoint of the user for viewing the at least one dimension from the viewpoint.

At 314, method 300 ends. Classification of each of the one or more information elements of the plurality of visually related multimedia information elements along the one or more dimensions is explained in greater detail in FIGS. 4A and 4B.

FIGS. 4A and 4B depict screenshots of an exemplary human-non human dimension of the one or more dimensions displayed to the user for positioning one or more information elements of the visually related multimedia information along the human-non human dimension, in accordance with an embodiment of the present disclosure. As explained in conjunction with FIG. 1, the human-non human dimension can be displayed to the user by a data processing device, such as data processing device 100, using a display module, such as display module 104.

Further, as explained in conjunction with FIG. 1, one or more dimensions are displayed to the user. The user can choose at least one dimension of the one or more dimensions for positioning the information element. Alternatively, the user can choose to position the information element along each dimension of the one or more dimensions. Further, positioning the information element along the at least one dimension classifies the information element. The classified information element can be stored, for example in a data processing device, using a storage module such as storage module 108. For positioning a subsequent information element, the classified information element is displayed to the user along with the at least one dimension. The user can then position the subsequent information element based on a visual comparison with the classified information element and can accordingly position the subsequent information element to a right side or a left side of the classified information element. For subsequent information elements, the classified information elements are displayed to the user for the at least one dimension. The user can position each information element based on a visual comparison of the each information element with the classified information elements.

In FIG. 4A, a human-non human dimension 400 is displayed to the user. Human-non human dimension 400 depicts four classified information elements, such as an information element 402, an information element 404, an information element 406 and an information element 408 along an axial line 400a. Information element 402 depicts a close-up image of a girl, information element 404 depicts a wide-angle image of a group of people, information element 406 depicts a close-up image of a dog's face and information element 408 depicts an image of a nature scene. The classified information elements are arranged progressively from information element 402 to information element 408 with information element 402 depicting the most human characteristic and information element 408 exhibiting the most non human characteristic. The user can position information elements 402-408 along other dimensions of the one or more dimensions, such as the lighting dimension, the proximity dimension, and the like. It will be obvious to a person skilled in the art, that information elements 402-408 can have a different arrangement when positioned along the other dimensions such as the lighting dimension or the proximity dimension.

FIG. 4B depicts positioning of an information element 410 along human-non human dimension 400 on axial line 400a. Information element 410 depicts an image of a man on a horse. As explained in conjunction with FIG. 1, the user may choose the human-non human dimension for positioning information element 410. Accordingly, the classified information elements 402-408 along human-non human dimension 400 are displayed to the user. The user can visually compare characteristics, such as presence of human characteristic in information element 410 vis-à-vis the human characteristics of information elements 402-408 for positioning information element 410 along human-non human dimension 400. Accordingly, the user may position information element 410, for example, in-between information element 404 and information element 406.

The user may then chose to position information element 410 along other dimensions, such as the lighting dimension or the proximity dimension, or the user may choose to position a subsequent information element. It will be evident to those skilled in the art that for an information element with no classified information elements for performing the visual comparison, the user can position the information element at an estimated position along the chosen dimension, according to the user judgment, and can place subsequent information elements along the chosen dimension on performing the visual comparison with the classified information element. In an embodiment of the present disclosure, the input classification module of the data processing device can include exemplar information elements for enabling the user to perform the visual comparison for positioning each information element of the plurality of visually related multimedia information elements. In another embodiment of the present disclosure, the user can be provided suggestions for positioning the information element. The classified information elements are stored in the storage module for facilitating easy retrieval of the classified information elements. The retrieval of the classified information elements is explained in conjunction with FIGS. 5A and 5B.

FIGS. 5A and 5B depict screenshots of exemplary distributions of information elements 402-410 (of FIGS. 4A and 4B) over a spatial region displayed to the user during retrieval of at least one information element of the classified information elements, in accordance with an embodiment of the present disclosure.

FIG. 5A depicts a screenshot of an exemplary distribution 500 of information elements 402-410 over a spatial region. Five dimensions, namely, a non human-human dimension 502, a manmade-natural dimension 504, a closeness dimension 506, a lighting dimension 508, and a chronology dimension 510, for configuring distribution 500, the dimensional display representation of the information volume, are displayed adjacent to distribution 500 as shown in FIG. 5A. Each of the five dimensions is depicted to display a scale providing a range selection option, such as the range selection option explained in conjunction with FIG. 3. The scale for each of the five dimensions depicts the classification maximum value and minimum value of the characteristic dimension of the information volume to be used for configuring the range values of the corresponding dimension of the dimensional display representation. For example, a scale for non human-human dimension 502, displays a minimum value of −20 and a maximum value of +20, while a scale for chronology dimension 510 depicts a minimum value of 1995 and a maximum value of 2010. It will be evident to those skilled in the art that the user can identify the minimum and maximum dimension range values for the display of a dimension of the dimensional display representation of the information volume by various means, such as by positioning a dimension range center pointer and entering a % Dimension Span value, as shown in 502-510 of FIGS. 5A and 5B. For example, a dimension range center pointer on the scale for the chronology dimension is placed in-between 2001 and 2002 dimension range values. Accordingly, the classified information elements corresponding to a period in-between 2001 and 2002 occur at the center of the axis to which the chronology dimension is assigned in the dimensional display representation of the information volume, and the percentage of the chronology dimension range, being the percentage of the chronology classification value range in the information volume, identified by the entered % Dimensional Span value, is distributed equally on either side of the axis center along the chronology display dimension for configuring distribution 500, the dimensional display representation of the information volume. Retrieved classified information elements having chronology classification values in-between 2001 and 2002 will be positioned at the center of the axis to which the chronology dimension is assigned in the dimensional display representation of the information volume, and classified information elements having chronology classification values prior to 2001 and after 2002 will be positioned on either side of the axis center along the chronology display dimension such that the spatial relationships of the classified information elements indicates their chronological distance from 2001-2002. In an embodiment of the present disclosure, the subset of the information volume selected for the dimensional display representation is formed of the Boolean AND of the selected dimensional ranges of the dimensional display representation. Classified information elements having a classification value outside of a selected value range are excluded from the dimensional display representation subset of the information volume. For example, in the case of a user entered % Dimensional Span of 50% for the chronology dimension 510 of FIG. 5A, and with the dimension range center pointer on the scale for the chronology dimension placed in-between 2001 and 2002, classified information elements having a chronology classification value of 1995 would be excluded from the dimensional display representation subset of the information volume.

For configuring distribution 500, the dimensional display representation of the information volume, as shown in FIG. 5A, in addition to identifying an information volume subset according to the range selection option for each dimension of the information volume, particular dimensions of the information volume can be assigned to particular dimensions of the dimensional display representation. In an embodiment of the present disclosure, as shown in the five dimensions of FIG. 5A, each of the dimensions of an information volume can be associated with a color code, each color code uniquely representing one of the at least one dimension in distribution 500, the dimensional display representation of the information volume, up to the limit of one color for each of the dimensions available in the dimensional display representation. For example, in the case of a two-dimensional display, because a two-dimensional display can represent a three dimensional volume, three of the five dimensions of FIG. 5A can be chosen for configuring distribution 500, assigning each of the three to a dimension of the dimensional display representation of the information volume. In an embodiment of the present disclosure as shown in FIG. 5A, the unique color code assigned to each dimension of the information volume that is selected to be included in the dimensional display representation will also be shown on the corresponding axis assigned in the dimensional display representation, thus indicating the each display axis assignment for each dimension of the information volume by means of the unique color codes. In an embodiment of the present disclosure, the selected dimension range subsets for the remaining dimensions of the information volume, such as two of the five dimensions in the example of FIG. 5A, can operate as pre-filters to exclude portions of the information volume from the dimensional display representation, for example with % Dimension Span set<100%, or, for example with % Dimension Span set to 100%, can have no constraining effect on the dimensional display representation. In FIG. 5A, closeness dimension 506 and chronology dimension 510 are chosen as the pre-filters. For the purposes of the description, a pre-filter can be regarded as means for filtering out a subset of the classified information elements of an information volume for display purposes such that the displayed subset dimensions of the information volume fit within the physical capabilities of the display device or such that the displayed subset of classified information elements of the information volume fit the user display needs. In FIG. 5A, none of the classified information elements are pre-filtered out because each of the % Dimension Span values are set to 100%. In this case classified information elements will not be excluded based on closeness or chronology classification values. All of the information elements of the information volume are included in the dimensional display representation of the information volume and are represented along the display dimensions, namely, non human-human dimension 502, manmade-natural dimension 504 and lighting dimension 508.

In FIG. 5A, the classified information elements are represented along the dimensions, namely, non human-human dimension 502 (represented on X-axis), manmade-natural dimension 504 (represented on Z-axis) and lighting dimension 508 (represented on Y-axis) for configuring distribution 500. It will be evident to those skilled in the art that for a display module with a three dimensional display, four dimensions can be selected for configuring distribution 500 and only one of the five dimensions can be chosen to pre-filter the classified information elements.

Thus, by pre-filtering the classified information elements and by selecting the dimension range values for at least one dimension, such as non human-human dimension 502, a user can retrieve the classified information elements such that the selected subset of the plurality of classified information elements is determined from the classification values of each information element according to the characteristics identified with the dimensions of the modified dimensional display representation and can use the method of the present disclosure to portray the retrieved classified information elements distributed over a spatial region according to the dimensional display representation in which spatial proximity among the one or more retrieved classified visually related multimedia information elements along each of the at least one dimensions represents the aspects of similarity and dissimilarity in the characteristic identified with the said dimension. In an embodiment of the present disclosure, the user can zoom into a particular portion of the spatial region of the dimensional display representation by appropriately selecting the dimension range values. In FIG. 5A, the orientation of the non human-human dimension 502 is horizontal and the orientation of the lighting dimension 508 is vertical. The user can provide an orientation input for altering an orientation of the at least one dimension for obtaining visualization of characteristic relationships between the classified information elements. An altered orientation of dimensions of distribution 500 is depicted in FIG. 5B.

In FIG. 5B, lighting dimension 508 represents the X-axis, non human-human dimension 502 represents the Y-axis and manmade-natural dimension 504 represents the Z-axis. The orientation of the dimensions can be altered based on the orientation input received from the user. It will be obvious to a person skilled in the art that altering the orientation of the dimensions changes a visual representation of spatial position of each of the classified information elements configuring a distribution 500a, as depicted in FIG. 5B. Altering the orientation can provide visual cues of the characteristic relationships between the classified information elements. For example, in FIG. 5B, altering the orientation of lighting dimension 508 and non human-human dimension 502 can enable the user to see variations in lighting characteristics of the classified information elements. Similarly other characteristic relationships can be conveyed to the user by appropriately selecting the orientation input for the at least one dimension.

Storing and retrieving visually related multimedia information, such as in data processing device 100, by utilizing a system, such as system 102 of the present disclosure, provides an effective mechanism for managing the visually related multimedia information in the data processing device. Further, classifying, storing and retrieving the visually related multimedia information using such a mechanism of continuously valued characteristics precludes the need of discrete on/off descriptors, such as alphanumeric keywords. Furthermore, the user can store and retrieve large visually related multimedia information sets, based on characteristics of the information elements in the visually related multimedia information sets in a natural and intuitive manner. Furthermore, displaying classified information elements along each dimension of one or more dimensions provides visual cues describing characteristic relationships among the information elements to the user. Further, distance between two classified information elements positioned along a dimension can indicate the degree of similarity between the two classified information elements in the characteristic identified with the dimension. Moreover, the positioning of the one or more information elements along the dimension can also provide information regarding the characteristics of the information elements.

It will be apparent to a person skilled in the art that the present disclosure as described above, can be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the present disclosure. When implemented on a general-purpose microprocessor, the computer program code segments configure the microprocessor to create specific logic circuits.

The foregoing description of several methods and an embodiment of the present disclosure have been presented for purposes of illustration. It is not intended to be exhaustive or to limit the present disclosure to the precise steps and/or forms disclosed, and obviously many modifications and variations are possible in light of the above description. It is intended that the scope of the present disclosure be defined by the claims appended hereto.

What is claimed is:

1. A method for managing visually related multimedia information, the visually related multimedia information comprising a plurality of information elements, each information element of the plurality of visually related multimedia information elements associated with one or more characteristics, the method comprising:
a) identifying one or more characteristics pertaining to visually related multimedia information, each said identified characteristic to be managed as a continuously valued dimension of interest in the storage and display of said visually related multimedia information, and,
b) positioning one or more information elements of the plurality of visually related multimedia information elements along the one or more said continuously valued dimensions, wherein positioning a visually related multimedia information element in each said dimension classifies said information element according to the characteristic identified with the said dimension, and,
c) retaining an information volume organized according to one or more continuously valued characteristic dimensions of interest, the information volume comprising a plurality of dimensionally positioned, and thereby classified, visually related multimedia information elements, and,
d) displaying one or more information elements of the plurality of dimensionally positioned visually related multimedia information elements distributed over a spatial region according to a dimensional display representation in which spatial proximity among the one or more visually related multimedia information elements along each of the at least one dimensions represents the aspects of similarity and dissimilarity in the characteristic identified with the said dimension, and,
e) adapting the dimensional orientation of the dimensional display representation, comprising the one or more continuously valued characteristic dimensions, and the associated displayed information volume, comprising a plurality of dimensionally positioned visually related multimedia information elements, based on one or more received user dimensional orientation requests.

2. The method of claim 1 wherein a characteristic pertaining to the visually related multimedia information is identified, and is managed as a continuously valued dimension, according to algorithmic analysis of the visually related multimedia information.

3. The method of claim 1 wherein a continuously valued characteristic dimension of interest is determined having a defined range.

4. The method of claim 3 further comprising identifying the characteristic dimension range values based on received user identification.

5. The method of claim 1 wherein a continuously valued characteristic dimension of interest is determined having an adaptive extent according to the information elements of the plurality of visually related multimedia information elements.

6. The method of claim 1 wherein a characteristic pertaining to the visually related multimedia information is identified, and is managed as a continuously valued dimension, based on received user identification.

7. The method of claim 6 wherein the range of a continuously valued characteristic dimension is defined according to input from a user providing visually related multimedia information elements identified as examples of the extremes of the range of the said characteristic dimension.

8. The method of claim 1 wherein a characteristic pertaining to visually related multimedia information is identified as having one or more discrete values, and wherein said characteristic is managed according to an ordered sequence of said discrete values aligned along a continuously valued dimension.

9. The method of claim 8 further comprising identifying the one or more discrete values for at least one dimension of the one or more dimensions based on received user identification.

10. The method of claim 1 wherein a characteristic pertaining to visually related multimedia information is managed according to a numeric scale aligned along a continuously valued dimension.

11. The method of claim 10 further comprising identifying the numeric scale of at least one continuously valued characteristic dimension based on received user identification.

12. The method of claim 1 wherein the one or more information elements of the plurality of visually related multimedia information elements is classified according to one or more continuously valued characteristic dimensions of interest using algorithmic analysis of said information element.

13. The method of claim 1 wherein the one or more information elements of the plurality of visually related multimedia information elements is classified according to the characteristic identified with a dimension by comparison to exemplar dimensionally positioned visually related multimedia information elements, said exemplars each having a distinct classification in the characteristic identified with the dimension.

14. The method of claim 13 wherein an information element of the plurality of visually related multimedia information elements is classified in the characteristic identified with a dimension according to a user input providing spatial positioning of said information element relative to displayed exemplars of the characteristic identified with the dimension.

15. The method of claim 1 wherein the stored information volume organized according to one or more continuously valued characteristic dimensions is retrieved and wherein a dimensional display representation is determined according to the one or more continuously valued characteristic dimensions of the said information volume.

16. The method of claim 15 wherein a user input from a user is received whereby the user optionally identifies a selected subset in each dimension of the one or more dimensions of an information volume, and further whereby the user optionally identifies one or more dimensions to exclude from, or include in, the dimensional display representation of the information volume.

17. The method of claim 16 wherein the collective result of the selected display options determines a modified dimensional display representation comprising a subset of the information volume, thereby comprising determination of a subset of the plurality of dimensionally positioned visually related multimedia information elements for display, wherein the selected subset of the said information elements is determined from the classification of each said information element according to the characteristics identified with the dimensions of the modified dimensional display representation.

18. The method of claim 17 wherein one or more dimensions are excluded from, or included in, the dimensional display representation of the information volume such that the dimensions of the dimensional display representation are appropriate to the dimensional capabilities of a display device.

19. The method of claim 17 further comprising determination of the dimensional orientation of the dimensional display representation such that the dimensional display representation of the information volume is rotated around a selected axis of the dimensional display representation, and further comprising determination of a user viewpoint located within the dimensional display representation, and further comprising determination of the displayed size of a selected region of the information volume and the displayed size of selected displayed information elements, based on received user instructions.

20. A system for managing visually related multimedia information, the visually related multimedia information comprising a plurality of information elements, each information element of the plurality of visually related multimedia information elements associated with one or more characteristics, the system comprising:
a) a display module capable to display visually related multimedia information, and,
b) a definition module capable to receive a user input from a user whereby the user identifies one or more characteristics pertaining to visually related multimedia information, each said identified characteristic to be managed as a continuously valued dimension of interest in the storage and display of said visually related multimedia information, and,
c) a input classification module capable to receive a user input from a user for positioning one or more information elements of the plurality of visually related multimedia information elements along at least one dimension of the one or more dimensions, wherein each information element of the plurality of visually related multimedia information elements is positioned along the one or more identified dimensions, wherein positioning a visually related multimedia information element in each dimension classifies said information element according to the characteristic identified with the dimension, and,
d) a storage module capable to retain an information volume organized according to one or more continuously valued characteristic dimensions of interest, the information volume comprising a plurality of dimensionally positioned, and thereby classified, visually related multimedia information elements, and,
e) wherein the display module is capable to display one or more information elements of the plurality of dimensionally positioned visually related multimedia information elements distributed over a spatial region according to a dimensional display representation in which spatial proximity among the one or more visually related multimedia information elements along each of the at least one dimensions represents the aspects of similarity and dissimilarity in the characteristic identified with the said dimension, and,
f) wherein the display module is capable to receive user input from a user to change the dimensional orientation of the dimensional display representation, comprising the one or more continuously valued characteristic dimensions, and the associated displayed information volume, comprising a plurality of dimensionally positioned visually related multimedia information elements.
